(19) United States
(12) Patent Application Publication
(10) Pub. No.: US 2018/0150755 A1
(43) Pub. Date: May 31, 2018

(54) ANALOGY-BASED REASONING WITH MEMORY NETWORKS FOR FUTURE PREDICTION

(71) Applicants: NEC Laboratories America, Inc., Princeton, NJ (US); NEC Corporation, Tokyo (JP)

(72) Inventors: Bing Bai, Princeton Junction, NJ (US); Daniel Andrade, Tokyo (JP)

(21) Appl. No.: 15/811,074

(22) Filed: Nov. 13, 2017

Related U.S. Application Data
(60) Provisional application No. 62/428,069, filed on Nov. 30, 2016.

(51) Int. Cl. G06N 5/04; G06F 9/54; G06F 9/38; G06K 9/62

(52) U.S. Cl. CPC G06N 5/04; G06K 9/6217; G06F 9/3838; G06F 9/542

(57) ABSTRACT

A method is provided that includes accessing a training set of positive and negative event pairs. The method includes calculating (i) positive similarity scores between an input pair of events and the positive event pairs, and (ii) negative similarity scores between the input pair of events and the negative event pairs. The method includes applying a Softmax process to (i) the positive similarity scores to produce an overall positive similarity score for the input pair of events, and (ii) the negative similarity scores to produce an overall negative similarity score for the input pair of events. The method includes calculating the difference between the overall positive and negative similarity scores to obtain a future event prediction score indicating a future occurrence likelihood of at least one of two events forming the input pair of events. The method includes performing an action responsive to the future event prediction score.

### RELATED APPLICATION INFORMATION

This application claims priority to provisional application Ser. No. 62/428,069, filed on Nov. 30, 2016, incorporated herein by reference.

### BACKGROUND

### Technical Field

The present invention relates to information processing, and more particularly to analogy-based reasoning with memory networks for future prediction.

### Description of the Related Art

Making predictions about what might happen in the future is important for reacting adequately in many situations. For example, observing that “Man kidnaps girl” may have the consequence that “Man kills girl”. While this is part of common sense reasoning for humans, it is not obvious how machines can learn and generalize over such knowledge automatically. Hence, there is a need for a technique to enable machines to make accurate future predictions.

### SUMMARY

According to an aspect of the present invention, a computer-implemented method is provided. The method includes accessing, by a processor, a training set of positive and negative event pairs. The method further includes calculating, by the processor, (i) positive similarity scores between an input pair of events and the positive event pairs in the training set, and (ii) negative similarity scores between the input pair of events and the negative event pairs in the training set. The method also includes applying, by the processor, a Softmax process to (i) the positive similarity scores to produce an overall positive similarity score for the input pair of events relative to the negative event pairs, and (ii) the negative similarity scores to produce an overall negative similarity score for the input pair of events relative to the positive event pairs. The method additionally includes calculating, by the processor, the difference between the overall positive similarity score and the overall negative similarity score to obtain a future event prediction score indicating a future occurrence likelihood of at least one of two constituent events forming the input pair of events. The method also includes performing, by the processor, an action responsive to the future event prediction score.

According to another aspect of the present invention, a computer program product is provided. The computer program product includes a non-transitory computer readable storage medium having program instructions embodied therewith. The program instructions are executable by a computer to cause the computer to perform a method. The method includes accessing, by a processor, a training set of positive and negative event pairs. The method further includes calculating, by the processor, (i) positive similarity scores between an input pair of events and the positive event pairs in the training set, and (ii) negative similarity scores between the input pair of events and the negative event pairs in the training set. The method also includes applying, by the processor, a Softmax process to (i) the positive similarity scores to produce an overall positive similarity score for the input pair of events relative to the negative event pairs, and (ii) the negative similarity scores to produce an overall negative similarity score for the input pair of events relative to the positive event pairs. The method additionally includes calculating, by the processor, the difference between the overall positive similarity score and the overall negative similarity score to obtain a future event prediction score indicating a future occurrence likelihood of at least one of two constituent events forming the input pair of events. The method also includes performing, by the processor, an action responsive to the future event prediction score.

According to yet another aspect of the present invention, a computer processing system is provided. The computer processing system includes a processing element. The processing element is configured to access a training set of positive and negative event pairs. The processing element is further configured to calculate (i) positive similarity scores between an input pair of events and the positive event pairs in the training set, and (ii) negative similarity scores between the input pair of events and the negative event pairs in the training set. The processing element is also configured to apply a Softmax process to (i) the positive similarity scores to produce an overall positive similarity score for the input pair of events relative to the negative event pairs, and (ii) the negative similarity scores to produce an overall negative similarity score for the input pair of events relative to the positive event pairs. The processing element is additionally configured to calculate the difference between the overall positive similarity score and the overall negative similarity score to obtain a future event prediction score indicating a future occurrence likelihood of at least one of two constituent events forming the input pair of events. The processing element is also configured to perform an action responsive to the future event prediction score.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary processing system to which the present principles may be applied, according to an embodiment of the present principles;

FIG. 2 is a block diagram showing an exemplary environment to which the present invention can be applied, in accordance with an embodiment of the present invention;

FIG. 3 is a high-level block diagram showing an exemplary mechanism for calculating a (happens-before) score for a pair of events, in accordance with an embodiment of the present invention;

FIGS. 4-5 are flow diagrams showing the functions performed by the mechanism of FIG. 3, in accordance with an embodiment of the present invention;

FIG. 6 is a flow diagram showing an exemplary training process, in accordance with an embodiment of the present invention;

FIG. 7 is a Venn diagram showing exemplary logical and temporal relation types, in accordance with an embodiment of the present invention; and

FIG. 8 shows four examples with input relations, output scores, and evidences, in accordance with an embodiment of the present invention.

### DETAILED DESCRIPTION OF PREFERRED EMBODIMENTS

The present invention is directed to analogy-based reasoning with memory networks for future prediction.

In an embodiment, the present invention exploits the distinction between logical relations and temporal relations. It has been noted that if an entailment relation holds between two events, then the second event is likely to be not a new future event. For example, the phrase “man kissed woman” entails that “man met woman”, where “man met woman” happens before (not after) “man kissed woman”. To find such entailments, we can leverage relation of verbs in a lexical database (e.g. of English, if the target language is English, otherwise, a different language could be used, while maintaining the spirit of the present invention), wherein nouns, verbs, adjectives and adverbs are grouped into sets of cognitive synonyms (synsets), each expressing a distinct concept. Synsets are interlinked by means of conceptual-semantic and lexical relations. Verbs that tend to be in a temporal (happens-before) relation have been extracted on a large scale. For example, we observe (subject, buy, object) tends to be temporally preceding (subject, use, object). We consider here entailment and (logical) implication as equivalent. In particular, synonyms are considered to be in an entailment relation.

In an embodiment, a model is presented that can predict future events given a current event triplet (subject, verb, object). To make the model generalizable to unseen events, a deep learning structure is adopted such that the semantics of unseen events can be learned through word/event embeddings. A novel Memory Comparison Network (MCN) is provided that can learn to compare and combine the similarity of input events to the event relations saved in memory.

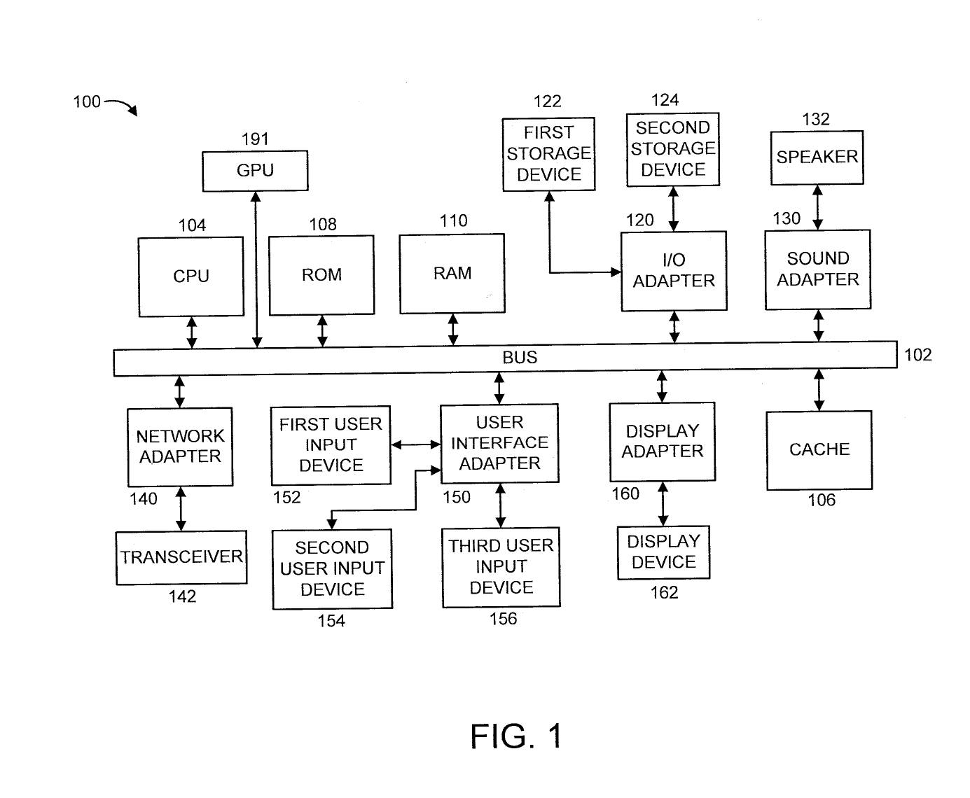

Referring now in detail to the figures in which like numerals represent the same or similar elements and initially to FIG. 1, a block diagram showing an exemplary processing system 100 to which the present principles may be applied, according to an embodiment of the present principles, is shown. The processing system 100 includes at least one processor (CPU) 104 operatively coupled to other components via a system bus 102. The system bus 102 can be formed from one or more bus types, e.g., having varying achievable communication speeds. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. A Graphics Processing Unit (GPU) 191 is operatively coupled to the system bus 102.

A first storage device 122 and a second storage device 124 are coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

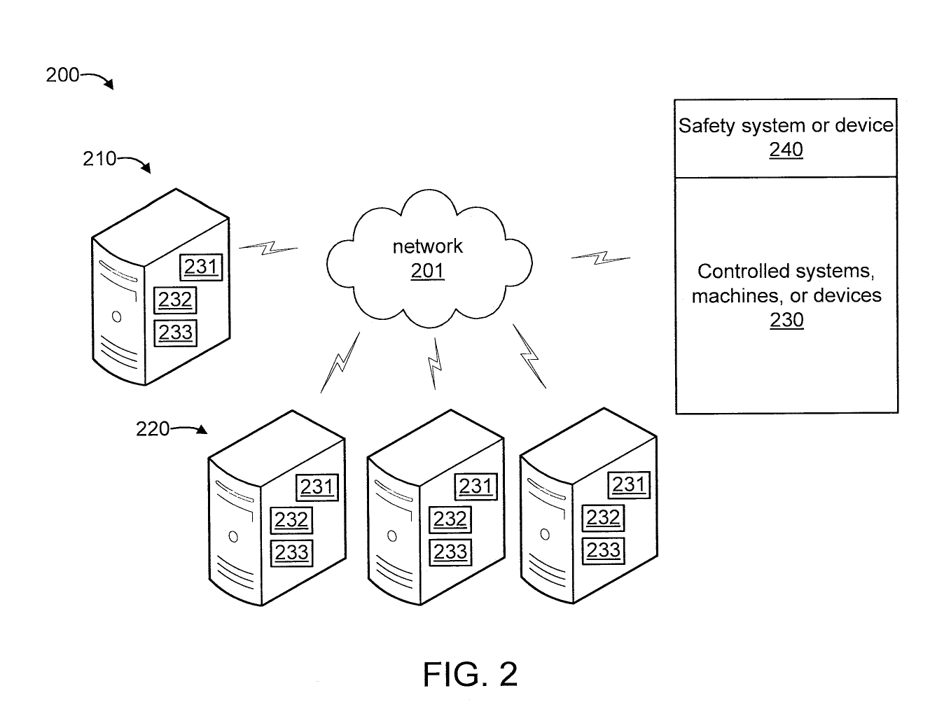

Moreover, it is to be appreciated that environment 200 described below with respect to FIG. 2 is an environment for implementing respective embodiments of the present principles. Part or all of processing system 100 may be implemented in one or more of the elements of environment 200.

Also, it is to be appreciated that mechanism 300 described below with respect to FIG. 2 is a mechanism for implementing respective embodiments of the present principles. Part or all of processing system 100 may be implemented in one or more of the elements of mechanism 300.

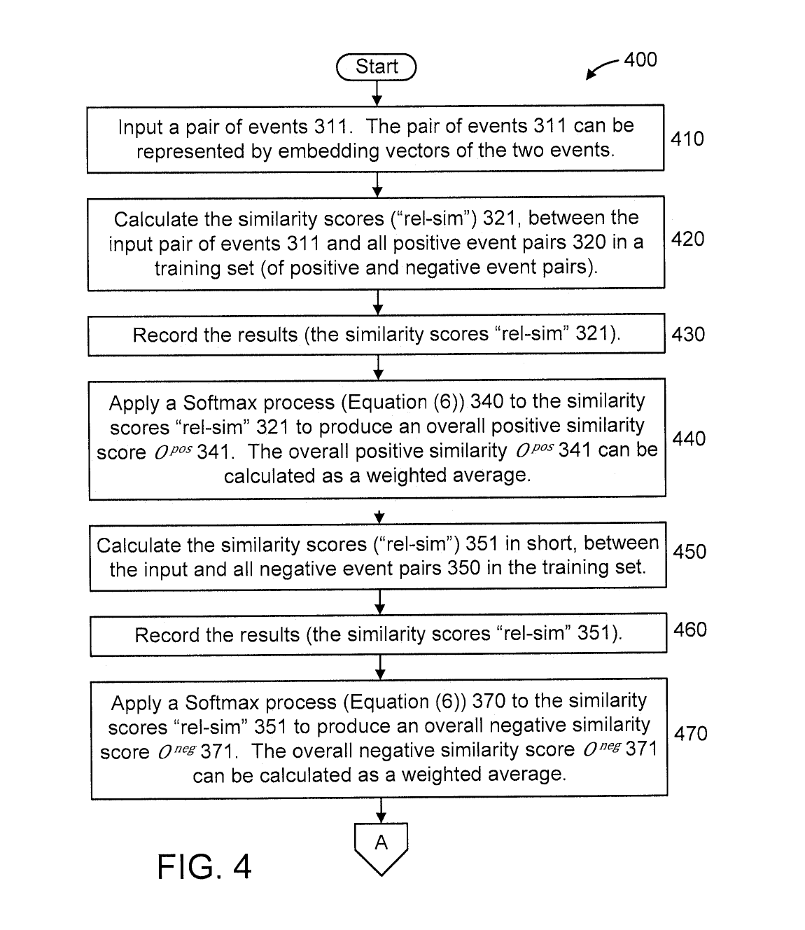

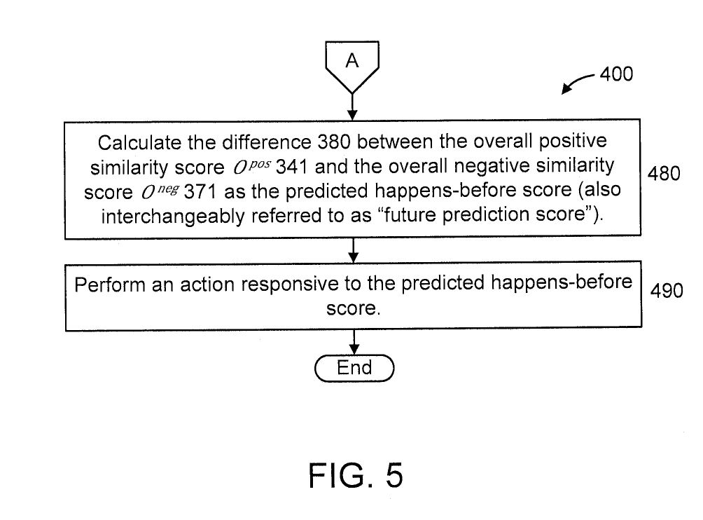

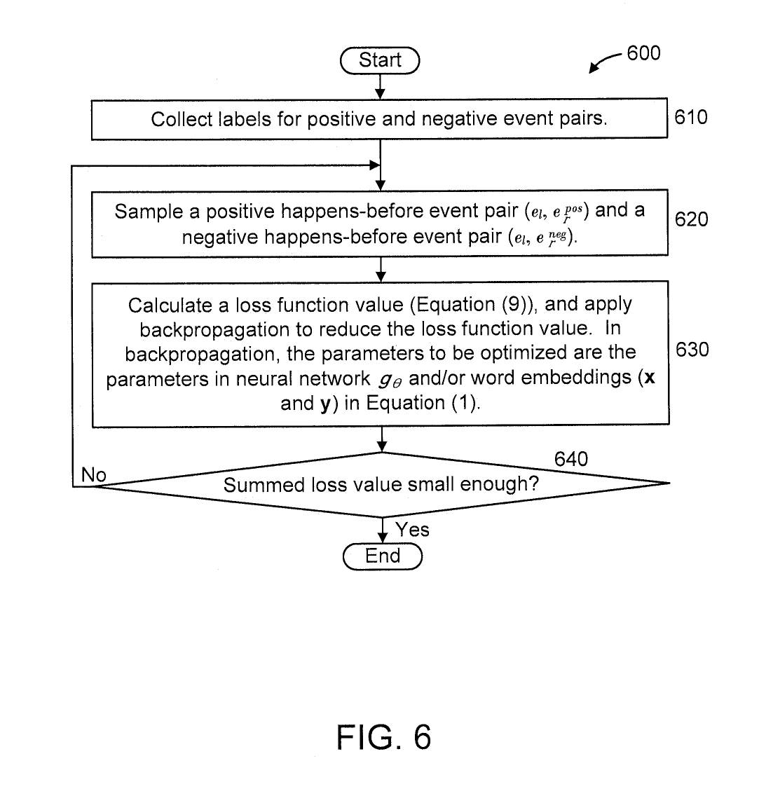

Further, it is to be appreciated that processing system 100 may perform at least part of the method described herein including, for example, at least part of method 400 of FIGS. 4-5 and/or at least part of method 600 of FIG. 6. Similarly, part or all of environment 200 may be used to perform at least part of method 400 of FIGS. 4-5 and/or at least part of method 600 of FIG. 6. Also, part or all of mechanism 300 may be used to perform at least part of method 400 of FIGS. 4-5 and/or at least part of method 600 of FIG. 6.

FIG. 2 is a block diagram showing an exemplary environment 200 to which the present invention can be applied, in accordance with an embodiment of the present invention. The environment 200 is representative of a computer network to which the present invention can be applied. The elements shown relative to FIG. 2 are set forth for the sake of illustration. However, it is to be appreciated that the present invention can be applied to other network configurations and other operational environments as readily contemplated by one of ordinary skill in the art given the teachings of the present invention provided herein, while maintaining the spirit of the present invention.

The environment 200 at least includes a computing node 210 operatively coupled to a set of computing nodes (e.g., servers, providers of services, etc.) 220.

Each of the computing node 210 and the computing nodes 220 at least include a processing element 231, a memory 232, and a communication device 233. The communication device 233 can be, for example, but is not limited to, a wireless transceiver, an Ethernet adapter, a Network Interface Card (NIC), and so forth.

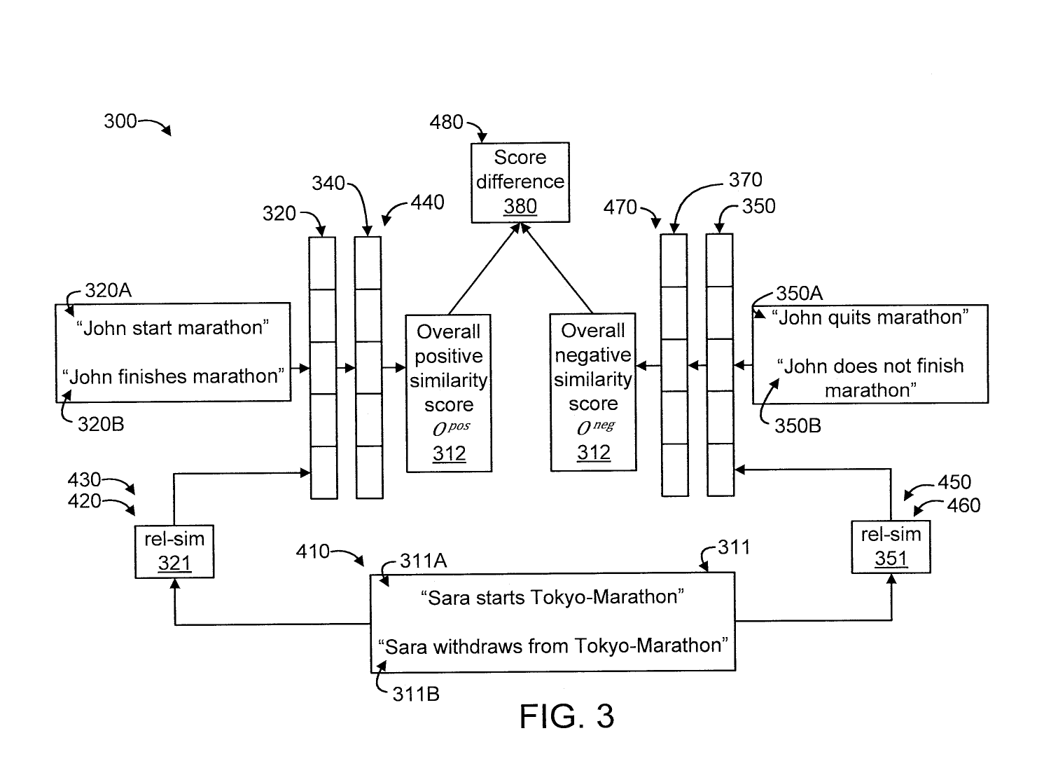

The computing node 210 is trained using training data. The training data can include, for example, positive event pairs and negative event pairs. The training data can be obtained from the set of computing nodes 220 or another source(s). The training data is used for analogy-based reasoning by a memory comparison network formed by and/or otherwise included in the computing node 210. The analogy-based reasoning can be implemented by a model or other data structure in order to generate prediction scores as described herein. The Softmax process described herein with respect to at least FIG. 3 can be implemented as a layer (e.g., the last) in a neural network, as readily appreciated by one of ordinary skill in the art, given the teachings of the present invention provided herein.

The computing node 210 receives testing data from the set of computing nodes 220. The computing node 210 then performs analogy-based reasoning using the memory comparison network to generate a future prediction.

The computing node 210 and/or any of the computing nodes 220 can be and/or otherwise include any type of computer processing system or device such as, but not limited to, servers, desktops, laptops, tablets, smart phones, media playback devices, and so forth, depending upon the particular implementation. For the sake of illustration, the computing node 210 and the computing nodes 220 are servers.

The computing node 210 can be configured to perform an action (e.g., a control action) on a controlled system, machine, and/or device 230 responsive to detecting an anomaly. Such action can include, but is not limited to, one or more of: applying an antivirus detection and eradication program; powering down the controlled system, machine, and/or device 230 or a portion thereof; powering down, e.g., a system, machine, and/or a device that is affected by an anomaly in another device, opening a valve to relieve excessive pressure (depending upon the anomaly), locking an automatic fire door, and so forth. As is evident to one of ordinary skill in the art, the action taken is dependent upon the type of anomaly and the controlled system, machine, and/or device 230 to which the action is applied.

In an embodiment, a safety system or device 240 can implement the aforementioned or other action, responsive to a control signal from the computing node 210. The safety system or device 240 can be used to control a shut off switch, a fire suppression system, an overpressure valve, and so forth. As is readily appreciated by one of ordinary skill in the art, the particular safety system or device 240 used depends upon the particular implementation to which the present invention is applied. Hence, the safety system 240 can be located within or proximate to or remote from the controlled system, machine, and/or device 230, depending upon the particular implementation.

In the embodiment shown in FIG. 2, the elements thereof are interconnected by a network(s) 201. However, in other embodiments, other types of connections can also be used. Additionally, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of environment 200 are readily determined by one of ordinary skill in the art, given the teachings of the present invention provided herein, while maintaining the spirit of the present invention.

FIG. 3 is a high-level block diagram showing an exemplary mechanism 300 for calculating a (happens-before) score for a pair of events, in accordance with an embodiment of the present invention. FIGS. 4-5 are flow diagrams showing the functions performed by the mechanism of FIG. 3, in accordance with an embodiment of the present invention.

At block 410, input a pair of events 311. The pair of events 311 can be represented by embedding vectors of the two events. In the example of FIGS. 3 and 4, the pair of events include “Sara starts Tokyo-Marathon” 311A and “Sara withdraws Tokyo-Marathon” 311B.

At block 420, calculate the similarity scores, referred to as relation similarity or “rel-sim” 321 in short, between the input pair of events 311 and all positive event pairs 320 in a training set (of positive and negative event pairs). In the example of FIG. 3, the positive event pairs include “John starts marathon” 320A and “John finishes marathon” 320B.

At block 430, record the results (the similarity scores “rel-sim” 321).

At block 440, apply a Softmax process (Equation (6)) 340 to the similarity scores “rel-sim” 321 to produce an overall positive similarity score O^{pos} 341 with respect to positive event pairs 320. In an embodiment, O^{pos} 341 can be calculated as a weighted average.

At block 450, calculate the similarity scores, referred to as relation similarity or “rel-sim” 351 in short, between the input and all negative event pairs 350 in the training set. In the example of FIG. 3, the negative event pairs 350 include “John quits marathon” 350A and “John does not finish marathon” 350B.

At block 460, record the results (the similarity scores “rel-sim” 351).

At step 470, apply a Softmax process (Equation (6)) 370 to the similarity scores “rel-sim” 351 to produce an overall negative similarity score O^{neg} 371 with respect to negative event pairs 350. In an embodiment, O^{neg} 371 can be calculated as a weighted average.

At step 480, calculate the difference 380 between the overall positive similarity score O^{pos} and the overall negative similarity score O^{neg} as the predicted happens-before score (also interchangeably referred to as “future prediction score”).

At step 490, perform an action responsive to the predicted happens-before score.

It is to be noted that for historical reasons, the score was named “happens-before score”. However, in practice, in another embodiment of the present invention, the score can also be treated as “happens-after score” if one fixes the first event. Thus, we use this score to predict the likeliness of a future event.

FIG. 6 is a flow diagram showing an exemplary training process 600, in accordance with an embodiment of the present invention.

At step 610, collect labels for positive and negative event pairs.

At step 620, sample a positive happens-before event pair (eₗ, eᵣ^{pos}) and a negative happens-before event pair (eₗ, eᵣ^{neg}).

At step 630, calculate a loss function value (Equation (9)), and apply backpropagation to reduce the loss function value. In backpropagation, the parameters to be optimized are the parameters in neural network go and/or word embeddings (x and y) in Equation (1).

At step 640, determine whether or not the summed loss value is small enough (e.g., below a threshold value). If so, then terminate the method. Otherwise, return to step 620.

A description will now be given regarding exploiting lexical features, in accordance with an embodiment of the present invention.

In an embodiment, the present invention is directed to distinguishing future events from other events. In texts, like news stories, an event eₗ is more likely to have happened before event eᵣ (temporal order), if eₗ occurs earlier in the text than eᵣ (textual order). However, there are also many situations where this is not the case: re-phrasing; introducing background knowledge; conclusions; and so forth. One obvious solution is discourse parsers. However, without explicit temporal markers, they suffer from low recall, and therefore in practice most script-learning systems use textual order as a proxy for temporal order. In an embodiment, the present invention explores whether common knowledge can help to improve future detection from event sequences in textual order.

In an embodiment, common knowledge is assumed to be given in the form of simple relations (or rules) like (company, buy, share)→(company, use, share), where “→” denotes the temporal happens-before relation. In contrast, we denote the logical entailment (implication) relation by “⇒”.

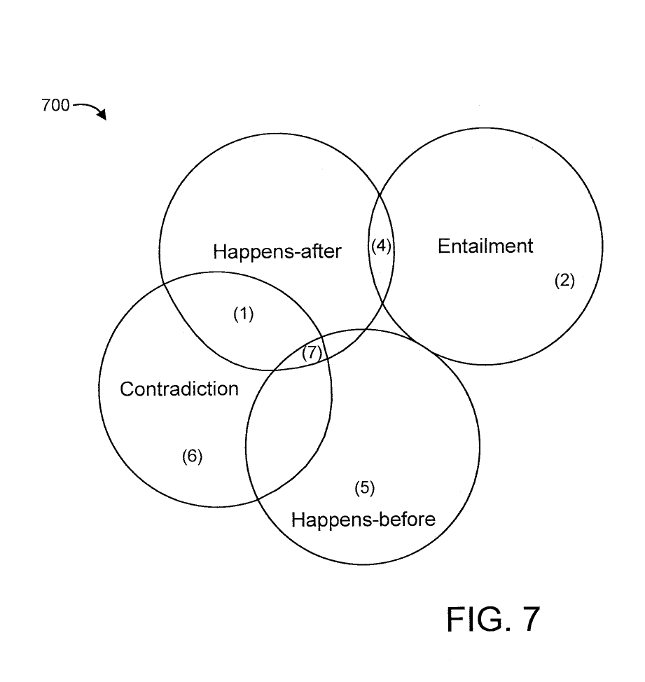

To extract such common knowledge rules, the use of the lexical resources is explored. In an embodiment, the lexical resources used included (1) the VerbOcean semantic network of verbs and (2) the WordNet lexical database of English. Of course, the present invention is not limited to the preceding lexical resources and, thus, other lexical resources can also be used in accordance with the teachings of the present invention, while maintaining the spirit of the present invention. Logical and temporal relations are not independent, but an interesting overlap exists as illustrated in FIG. 7, and corresponding examples of temporal and logical relations shown in TABLE 1. That is, FIG. 7 is a Venn diagram showing various logical and temporal relations 700 to which the present invention can be applied, in accordance with an embodiment of the present invention. Examples of the relations are shown in TABLE 1. It is noted that, for temporal relations, the situation is not always as clear cut as shown in FIG. 7 (e.g. repeated actions). Nevertheless, there is a tendency of event relations belonging mostly only to one relation. In particular, in the following, we consider “wrong” happens-before relations, as less likely to be true than “correct” happens-before relations.

TABLE 1
Examples

(1) “minister leaves factory”, “minister enters factory”
(2) “company donates money”, “company gives money”
(3) “John starts marathon”, “John finishes marathon”
(4) “governor kisses girlfriend”, “governor meets girlfriend”
(5) “people buy apple”, “people use apple”
(6) “minister likes criticism”, “minister hates criticism”
(7) “X's share falls 10%”, “X's share rises 10%”

A description will now be given regarding data creation, m accordance with an embodiment of the present invention.

For simplicity, we restrict our investigation here to events of the form (subject, verb, object). In an embodiment, events are extracted from around 790 k English news articles. The news articles were pre-processed using the Stanford dependency parser and co-reference resolution. We lemmatized all words, and for subjects and objects we considered only the head words, and ignored words like WH-pronouns.

All relations are defined between two events of the form (S, Vₗ, O) and (S, Vᵣ, O) where subject S and object O are the same. As candidates, only events in sequence (occurrence in text) were considered.

A description will now be given regarding positive samples, in accordance with an embodiment of the present invention.

Positive samples are extracted of the form (S, Vₗ, O)→(S, Vᵣ^{pos}, O), if

1. Vₗ→Vᵣ^{pos} is listed in VerbOcean as happens-before relation.
2. ¬[Vₗ⇒Vᵣ^{pos}] according to WordNet. That means, for example, if (S, Vᵣ, O) is paraphrasing (S, Vₗ, O), then this is not considered as a temporal relation.

This way, we were able to extract 1699 positive samples. Examples of happens-before relations extracted from news articles are shown in TABLE 2.

A description will now be given regarding negative samples, in accordance with an embodiment of the present invention.

Using VerbOcean, we extracted negative samples of the form (S, V₁, O) [symbol] (S, Vᵣ^{neg}, O) i.e., the event on the left hand (S, Vₗ, O) is the same as for a positive sample. If (S, Vₗ, O) [symbol] (S, Vᵣ^{neg}, O), then Vₗ→Vᵣ^{neg} is not listed in VerbOcean. This way, we extracted 1177 negative samples.

TABLE 2
Examples

(company, buy, share) → (company, use, share)
(ex-husband, stalk, her) → (ex-husband, kill, her)
(farmer, plant, acre) → (farmer, harvest, acre)

There are several reasons for a relation not being in a temporal relation. Using VerbOcean and WordNet we analyzed the negative samples, and found that the majority (1030 relations) could not be classified with either VerbOcean or WordNet. We estimated conservatively that around 27% of these relations are false negatives: for a sub-set of 100 relations, we labeled a sample as a false negative, if it can have an interpretation as a happens-before relation. Therefore, this over-estimates the number of false negatives. This is because it also counts a happens-before relation that is less likely than a happens-after relation as a false negative.

To simplify the task, we created a balanced data set, by pairing all positive and negative samples: each sample pair contains one positive and one negative sample, and the task is to find that the positive sample is more likely to be a happens-before relation than a negative sample. The resulting data set contains in total 1765 pairs.

A description will now be given regarding analogy-based reasoning for happens-before relation scoring, in accordance with an embodiment of the present invention.

In the following, let r be a happens-before relation of the form:

r: eₗ→eᵣ

where eₗ and eᵣ are two events of the form (S, Vₗ, O) and (S, Vᵣ, O) respectively. Furthermore, let e′ be any event of the form (S′, V′, O′).

Our working hypotheses consists of the following two claims:

(I) If (e′ ⇒eₗ)̂(eₗ→eᵣ), then e′→eᵣ.
(II) If (e′⇒eᵣ)̂(eₗ→eᵣ), then eₗ→e′.

For example, consider the following:

“John buys computer”⇒“John acquires computer”,

“John acquires computer”→“John uses computer”.

Using (I), we can reason that:

“John buys computer”→“John uses computer”.

We note that, in some cases, “⇒” in (I) and (II) cannot be replace by “⇐”. This is illustrated by the following example:

“John knows Sara” 4⇐“John marries Sara”,

“John marries Sara”→“John divorces from Sara”.

However, the next statement is considered wrong (or less likely to be true):

“John knows Sara”→“John divorces from Sara”.

In practice, using word embeddings, it can be difficult to distinguish between “⇒” and “⇐”. Therefore, our proposed method uses the following simplified assumptions:

(I*) If (e′˜e)̂(eₗ→eᵣ), then e′ →eᵣ.
(II*) If (e′ ˜eᵣ)̂(eₗ→eᵣ), then eₗ→e′.
where ˜ denotes some similarity that can be measured by means of word embeddings.

A description will now be given regarding a memory comparison network, in accordance with an embodiment of the present invention.

We propose a memory-based network model that uses the assumptions (I*) and (II*). It bases its decision on one (or more) training samples that are similar to a test sample. In contrast to other methods like neural networks for script learning, and (non-linear) SVM ranking models, it has the advantage of giving an explanation of why a relation is considered (or not considered) as a happens-before relation.

In the following, let r₁ and r₂ be two happens-before relations of the form:

r₁: (S₁,Vₗ₁,O₁)→(S₁,Vᵣ₁,O₁)

r₂: (S₂,Vₗ₂,O₂)→(S₂,Vᵣ₂,O₂)

Let xₛᵢ, x_{ν}_{ₗᵢ},

$${x}_{{v}_{{r}_{i }}}$$

and xₒ_{ᵢ}ϵ [symbol] ^{d} denote the word embeddings corresponding to Sᵢ, Vₗᵢ, Vᵣᵢ and Oᵢ. Regarding notation: we use bold fonts, like v to denote a column vector; ν^{T} to denote the transpose, and νₜ to denote the t-th dimension of ν.

We define the similarity between two relations r₁ and r₂ as follows:

$$sim θ ( {r}_{1} ; {r}_{2} ) = g θ ( {x}_{{v}_{{l}_{1}}}^{T} {x}_{{v}_{{l}_{2}}} ) + g θ ( {x}_{{v}_{{r}_{1}}}^{T} {x}_{{v}_{{r}_{2}}} ) \qquad ( 1 )$$

where gθ is an artificial neuron with θ={σ, β}, a scale σϵ [symbol] , and a bias βϵ [symbol] parameter, followed by a non-linearity. We use as non-linearity the sigmoid function. Furthermore, here we assume that all word embeddings are l2-normalized.

Given the input relation r: eₗ→eᵣ, we test whether the relation is correct or wrong as follows. Let nₚₒₛ and n_{neg} denote the number of positive and negative training samples, respectively. First, we compare to all positive and negative training relations in the training data set, and denote the resulting vectors as u^{pos}ϵ [symbol] ⁿ^{ₚₒₛ} and u^{neg} ϵ [symbol] ⁿ^{_{neg}}, respectively. That is formally the following:

uₜ^{pos}=simθ(r,rₜ^{pos}) and uₜ^{neg}=simθ(r,rₜ^{neg})

where rₜ^{pos} and rₜ^{neg} denotes the t-th positive/negative training sample.

Next, we define the score that r is correct/wrong as the weighted average of the relation similarities:

o^{pos}=softmax_{γ}(u^{pos})^{T}u^{pos} and o^{neg}=softmax_{γ}(u^{neg})^{T}u^{neg} (2)

where softmax_{γ}(u) returns a column vector with the t-th output defined as

$$soft {max}_{γ} = {( u )}_{t} = \frac{{e}^{γ {u}_{t}}}{{Σ}_{i} {e}^{γ {u}_{i}}}$$

and γϵ [symbol] is a weighting parameter. Note that for γ→∞, softmax_{γ}(u)=max(u), and for γ=0, o is the average of u.

Finally, we define the happens-before score for r as follows:

l(eₗ,eᵣ)=o^{pos}(eₗ,er)−o^{neg}(e^{l},eᵣ) (3)

The score l(eₗ, eᵣ) can be considered as an unnormalized log probability that relation r is a happens before relation. The basic components of the network are illustrated in FIG. 3 described above.

For optimizing the parameters of our model we minimize the rank margin loss:

L(r^{pos},r^{neg})=max{0,1−l(eₗ,eᵣ^{pos})+l(eₗ,eᵣ^{nrg}))} (4)

where r^{pos}:eₗ→eᵣ^{pos} and r^{neg}:eₗ→eᵣ^{neg} are positive and negative samples from the held-out training data. All parameters of the models are trained using stochastic gradient descent (SGD). Word embeddings (xₛ, x_{ν}, and xₒ) are kept fixed during training.

Our model can be interpreted as an instance of a memory network, where notation-wise I(·) corresponds to the word embedding lookup, G(·) saves all training samples into the memory, the O(·) function corresponds to (o^{pos}, o^{neg}), and the output of R(·) equals Equation (3).

Regarding the model of the present invention, it has similarity to a memory-based reasoning system with at least the two following differences. First, we use here a trainable similarity measure (see Equation (1)), rather than a fixed distance measure. Second, we use the trainable Softmax rather than max.

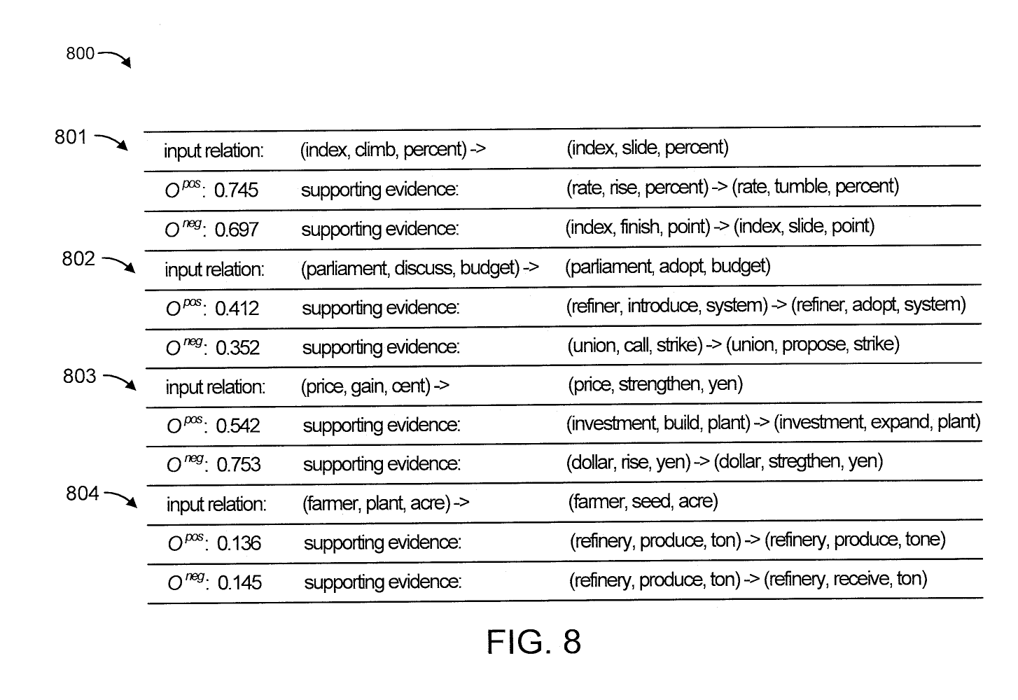

FIG. 8 shows four examples 801-804 with input relations, output scores, and evidences, in accordance with an embodiment of the present invention.

Since the model of the present invention uses analogy-based reasoning, it can easily identify supporting evidence for the output of our system. In an embodiment, the supporting evidence can denote the training sample with the highest similarity sim_{θ} to the input. In the first example 801 and the second example 802, the input is a happens-before relation, in the third example 803 and the fourth example 804, the input is not a happens-before relation. It is to be appreciated that the preceding examples are merely illustrative and, thus, the present invention can be applied to many other applications and corresponding triples. The applications can include, for example, surveillance (man, enter, private area), (private area, secure, lock), and so forth, as readily appreciated by one of ordinary skill in the art.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method, comprising:
accessing, by a processor, a training set of positive and negative event pairs;
calculating, by the processor, (i) positive similarity scores between an input pair of events and the positive event pairs in the training set, and (ii) negative similarity scores between the input pair of events and the negative event pairs in the training set;
applying, by the processor, a Softmax process to (i) the positive similarity scores to produce an overall positive similarity score for the input pair of events relative to the negative event pairs, and (ii) the negative similarity scores to produce an overall negative similarity score for the input pair of events relative to the positive event pairs;
calculating, by the processor, the difference between the overall positive similarity score and the overall negative similarity score to obtain a future event prediction score indicating a future occurrence likelihood of at least one of two constituent events forming the input pair of events; and
performing, by the processor, an action responsive to the future event prediction score.

2. The computer-implemented method of claim 1, wherein the input pair of events are represented by embedding vectors of the two constituent events forming the input pair of events.

3. The computer-implemented method of claim 1, wherein the overall positive similarity score and the overall negative similarity score are produced as respective weighted averages.

4. The computer-implemented method of claim 1, wherein the overall positive similarity score and the overall negative similarity score are produced using distinctly executable instances of the Softmax process running in parallel.

5. The computer-implemented method of claim 1, wherein the training set is trained by:
collecting labels for the positive event pairs and the negative event pairs in the training set;
sampling a given one of the positive event pairs and a given one of the negative event pairs from the training set; and
calculating a loss function value relating at least to the given one of the positive event pairs and the given one of the negative event pairs, and applying backpropagation to reduce the loss function value.

6. The computer-implemented method of claim 1, wherein constituent events forming each of the positive event pairs and the negative event pairs in the training set have at least one relation there between selected from the group consisting of a temporal relation and a logical relation.

7. The computer-implemented method of claim 1, wherein the input pair of events and the event pairs in the training set are triplets having a form of (subject, verb, object).

8. The computer-implemented method of claim 1, wherein event pair similarity between compared event pairs is based on word embeddings derived for the compared event pairs.

9. The computer-implemented method of claim 1, wherein the method further comprising providing supporting evident for the future prediction score as a triple having a form of (subject, verb, object).

10. The computer-implemented method of claim 1, wherein the triple provided as the supporting evidence comprises an event pair from the training data having a highest similarity to the input pair of events, the event pair selected from the group consisting of positive event pairs and negative event pairs in the training data.

11. A computer program product, the computer program product comprising a non-transitory computer readable storage medium having program instructions embodied therewith, the program instructions executable by a computer to cause the computer to perform a method comprising:
accessing, by a processor, a training set of positive and negative event pairs;
calculating, by the processor, (i) positive similarity scores between an input pair of events and the positive event pairs in the training set, and (ii) negative similarity scores between the input pair of events and the negative event pairs in the training set;
applying, by the processor, a Softmax process to (i) the positive similarity scores to produce an overall positive similarity score for the input pair of events relative to the negative event pairs, and (ii) the negative similarity scores to produce an overall negative similarity score for the input pair of events relative to the positive event pairs;
calculating, by the processor, the difference between the overall positive similarity score and the overall negative similarity score to obtain a future event prediction score indicating a future occurrence likelihood of at least one of two constituent events forming the input pair of events; and
performing, by the processor, an action responsive to the future event prediction score.

12. The computer program product of claim 11, wherein the input pair of events are represented by embedding vectors of the two constituent events forming the input pair of events.

13. The computer program product of claim 11, wherein the overall positive similarity score and the overall negative similarity score are produced as respective weighted averages.

14. The computer program product of claim 11, wherein the overall positive similarity score and the overall negative similarity score are produced using distinctly executable instances of the Softmax process running in parallel.

15. The computer program product of claim 11, wherein the training set is trained by:
collecting labels for the positive event pairs and the negative event pairs in the training set;
sampling a given one of the positive event pairs and a given one of the negative event pairs from the training set; and
calculating a loss function value relating at least to the given one of the positive event pairs and the given one of the negative event pairs, and applying backpropagation to reduce the loss function value.

16. The computer program product of claim 11, wherein constituent events forming each of the positive event pairs and the negative event pairs in the training set have at least one relation there between selected from the group consisting of a temporal relation and a logical relation.

17. The computer program product of claim 11, wherein the method further comprising providing supporting evident for the future prediction score as a triple having a form of (subject, verb, object).

18. The computer program product of claim 11, wherein event pair similarity between compared event pairs is based on word embeddings derived for the compared event pairs.

19. The computer program product of claim 11, wherein the triple provided as the supporting evidence comprises an event pair from the training data having a highest similarity to the input pair of events, the event pair selected from the group consisting of positive event pairs and negative event pairs in the training data.

20. A computer processing system, comprising:
a processing element, configured to
access a training set of positive and negative event pairs;
calculate (i) positive similarity scores between an input pair of events and the positive event pairs in the training set, and (ii) negative similarity scores between the input pair of events and the negative event pairs in the training set;
apply a Softmax process to (i) the positive similarity scores to produce an overall positive similarity score for the input pair of events relative to the negative event pairs, and (ii) the negative similarity scores to produce an overall negative similarity score for the input pair of events relative to the positive event pairs;
calculate the difference between the overall positive similarity score and the overall negative similarity score to obtain a future event prediction score indicating a future occurrence likelihood of at least one of two constituent events forming the input pair of events; and
perform an action responsive to the future event prediction score.
